(19) United States
(12) Patent Application Publication
(10) Pub. No.: US 2022/0008908 A1
(43) Pub. Date: Jan. 13, 2022

(54) METHODS OF PRODUCING HYDROCRACKING CATALYST

(71) Applicants: Saudi Arabian Oil Company, Dhahran (SA); JGC Catalysts and Chemicals Ltd., Kawasaki-shi (JP); Japan Cooperation Center Petroleum, Tokyo (JP)

(72) Inventors: Omer Refa Koseoglu, Dhahran (SA); Robert Peter Hodgkins, Dhahran (SA); Mitsunori Watabe, Kanagawa (JP); Koji Uchida, Kanagawa (JP)

(73) Assignees: Saudi Arabian Oil Company, Dhahran (SA); JGC Catalysts and Chemicals Ltd., Kawasaki-shi (JP); Japan Cooperation Center Petroleum, Tokyo (JP)

(21) Appl. No.: 16/923,346

(22) Filed: Jul. 8, 2020

(51) Int. Cl. B01J 37/30; B01J 6/00; B01J 37/00; C10G 47/12; B01J 29/08

(52) U.S. Cl. CPC B01J 37/30; B01J 6/001; B01J 29/088; C10G 47/12; B01J 37/0009

(57) ABSTRACT

A method for producing a hydrocracking catalyst includes preparing a framework substituted Y-type zeolite, preparing a binder, co-mulling the framework substituted Y-type zeolite, the binder, and one or more hydrogenative metal components to form a catalyst precursor, and calcining the catalyst precursor to generate the hydrocracking catalyst. The framework substituted Y-type zeolite is prepared by calcining a Y-type zeolite at 500° C. to 700° C. to form a calcined Y-type zeolite. Further, the framework substituted Y-type zeolite is prepared by forming a suspension containing the calcined Y-type zeolite, the suspension having a liquid to solid mass ratio of 5 to 15, adding acid to adjust the pH of the suspension to less than 2.0, adding and mixing one or more of a zirconium compound, a hafnium compound, or a titanium compound to the suspension, and neutralizing the pH of the suspension to obtain the framework substituted Y-type zeolite.

### TECHNICAL FIELD

Embodiments of the present specification generally relate to hydrocracking catalysts, and specifically relate to methods of preparing hydrocracking catalyst with co-mulling of all catalyst components.

### BACKGROUND

Hydrocracking processes are commonly used throughout the hydrocarbon processing industry including a large number of petroleum refineries. They are used to process a variety of feeds boiling in the range of 370° to 5200 in conventional hydrocracking units and boiling at 520° and above in the residue hydrocracking units. In general, hydrocracking processes split the heavy large molecules of the feed into smaller (lighter) molecules having greater average volatility and economic value. Additionally, hydrocracking processes typically improve the quality of the hydrocarbon feedstock by increasing the hydrogen to carbon ratio and by removing organosulfur and organonitrogen compounds. The significant economic benefit derived from hydrocracking processes has resulted in substantial development of process improvements and more active catalysts.

Hydrotreating and hydrocracking units generally include two principal zones, reaction and separation. Key parameters such as feedstock quality, product specification/processing objectives and catalysts typically determine the configuration of the reaction zone.

Mild hydrocracking or single stage once-through hydrocracking occurs at operating conditions that are more severe than hydrotreating processes, and less severe than conventional full pressure hydrocracking processes. This hydrocracking process is more cost effective, but typically results in lower product yields and quality. The mild hydrocracking process produces less mid-distillate products of a relatively lower quality as compared to conventional hydrocracking. Single or multiple catalysts systems can be used depending upon the feedstock processed and product specifications. Single stage hydrocracking is the simplest configuration, and is designed to maximize mid-distillate yields over a single or dual catalyst system. Dual catalyst systems are used in a stacked-bed configuration or in two different reactors.

In a series-flow configuration, the entire hydrotreated/hydrocracked product stream from the first reactor, including light gases including C1-C4, H₂S, NH₃, and all remaining hydrocarbons, are sent to the second reactor. In two-stage configurations, the feedstock is refined by passing it over a hydrotreating catalyst bed in the first reactor. The effluents are passed to a fractionator column to separate the H₂S, NH₃, light gases (C1-C4), naphtha and diesel products boiling in the temperature range of 36-3700 The hydrocarbons boiling above 3700 are then passed to the second reactor.

In a two-stage hydrocracking configuration, the feedstock is hydrotreated/hydrocracked in a first reactor over a hydrotreating catalyst bed, usually comprising amorphous based catalyst(s), such as amorphous alumina or silica alumina substrates containing Ni/Mo, Ni/W or Co/Mo metals as the active phase. The first reactor effluents are then fractionated, and the light fractions containing H₂S, NH₃, C1-C4 gases, naphtha and diesel fractions boiling up to a nominal boiling point of 370° are separated. The hydrocarbon fraction boiling above 370° is then sent to the second reactor containing amorphous and/or zeolite based catalyst(s) having Ni/Mo or Ni/W metals as the active phase. The effluents from the second reactor are sent to the fractionator in a combined stream with effluent from the first reactor, for separation of cracked components.

Each of the hydrocracking reactors require a hydrocracking catalyst for operation. As such, operation and maintenance of a hydrocracking reactor may be costly with the necessary acquisition and replacement of catalysts during operation.

### SUMMARY

Accordingly, there is a clear and long-standing need to provide an efficient and economical process for the production of hydrocracking catalysts. Embodiments of the present disclosure are related to a method for producing a hydrocracking catalyst including elimination of previously required processing steps while maintaining ultimate functionality to reduce the cost and time required for preparation of hydrocracking catalysts.

In accordance with one or more embodiments of the present disclosure, a method for producing a hydrocracking catalyst is disclosed. The method includes preparing a framework substituted Y-type zeolite, preparing a binder, co-mulling the framework substituted Y-type zeolite, the binder, and one or more hydrogenative metal components to form a catalyst precursor, and calcining the catalyst precursor to generate the hydrocracking catalyst. Further, the framework substituted Y-type zeolite is prepared by calcining a Y-type zeolite at 500° C. to 700° C. to form a calcined Y-type zeolite, the Y-type zeolite having a crystal lattice constant failing in an inclusive range of 2.430 to 2.450 nanometers (nm), a specific surface area of 600 to 900 square meters per gram (m²/g), and a molar ratio of SiO₂ to Al₂O₃ of 20 to 100; forming a suspension containing the calcined Y-type zeolite, the suspension having a liquid to solid mass ratio of 5 to 15; adding acid to adjust the pH of the suspension to less than 2.0; adding and mixing one or more of a zirconium compound, a hafnium compound, or a titanium compound to the suspension to the suspension; and neutralizing the pH of the suspension to obtain the framework substituted Y-type zeolite.

Additional features and advantages of the described embodiments will be set forth in the detailed description which follows, and in part will be readily apparent to those skilled in the art from that description or recognized by practicing the described embodiments, including the detailed description which follows and the claims.

### DETAILED DESCRIPTION

Reference will now be made in detail to embodiments of a method for producing a hydrocracking catalyst.

Methods for producing a hydrocarbon catalyst in accordance with one or more embodiments of the present disclosure generally comprise preparing a framework substituted Y-type zeolite, preparing a binder, co-mulling the framework substituted Y-type zeolite, the binder, and one or more hydrogenative metal components to form a catalyst precursor, and calcining the catalyst precursor to generate the hydrocracking catalyst. The preparation of the framework substituted Y-type zeolite, preparation of the binder, co-mulling of the various components, and calcining to form the hydrocracking catalyst will be discussed in greater detail throughout the present disclosure. The properties of the numerous components of the hydrocracking catalyst and the resulting hydrocracking catalyst produced in accordance with the presently disclosed method will also be disclosed.

It will be appreciated that co-mulling the framework substituted Y-type zeolite, the binder, and one or more hydrogenative metal components to form a catalyst precursor in a single step allows for the preparation of the hydrocracking catalyst without additional calcination and separate metal impregnation steps required in previous methods of forming hydrocracking catalysts in accordance with the type of the present disclosure. Specifically, previous methods have required separate calcination of a mixture of the framework substituted Y-type zeolite and the binder before a separate metals impregnation procedure. The additional steps and unit operations necessitated by previous methods results in both a more costly and complicated method of preparing the hydrocracking catalyst. As such, it will be appreciated that the methods of the present disclosure allow for the elimination of multiple steps of previous methods while retaining the ultimate functionality of the resulting hydrocracking catalyst.

As an initial step, framework substituted Y-type zeolite is produced or provided for preparation of the hydrocracking catalyst. The framework substituted Y-type zeolite may be produced, for example, according to a method as described below.

The framework substituted Y-type zeolite may be produced in accordance with a method comprising calcining an ultra-stable Y-type zeolite at 500° C. to 700° C., the ultra-stable Y-type zeolite having a crystal lattice constant of 2.430 to 2.450 nm, a specific surface area of 600 to 900 m²/g, and a molar ratio of SiO₂ to Al₂O₃ of 20 to 100. Further, producing the framework substituted Y-type zeolite comprises forming a suspension containing the calcined ultra-stable Y-type zeolite, the suspension having a liquid/solid mass ratio of 5 to 15 and adding an acid to adjust the pH of the suspension to less than 2.0. Subsequently, the method of forming the framework substituted Y-type zeolite comprises adding a solution containing one or more of a zirconium compound, a hafnium compound, or a titanium compound. Mixing, and then neutralizing the solution with, for example, an aqueous ammonia in such a manner that the mixed solution has a pH of about 7. The above production method shall be described in greater detail throughout the present disclosure.

Ultra-stable Y-type zeolite is used as one of the raw materials for preparing the framework substituted Y-type zeolite in accordance with one or more embodiments of the present disclosure. The ultra-stable Y-type zeolite as utilized in the methods of the present disclosure is familiar to one having skill in the art, and a production method to form the ultra-stable Y-type zeolite shall not specifically be restricted. The ultra-stable Y-type zeolite utilized in the present disclosure includes zeolites having a crystal lattice constant (UD) falling in a range of 2.430 nm to 2.450 nm, a specific surface area of 600 to 900 m²/g and a molar ratio (silica-alumina ratio) falling in a range of 20 to 100 in terms of SiO₂ to Al₂O₃. Further details regarding the ultra-stable Y-type zeolite are provided subsequent to the detailed disclosure of the present method.

Having indicated a production method to form the ultra-stable Y-type zeolite shall not specifically be restricted, an example production method is provided. In accordance with one or more embodiments of a production method for the ultra-stable Y-type zeolite, a NaY-type zeolite synthesized by a common method is subjected to exchange of sodium ions with ammonium ions by a conventional method. For example, exchange of sodium ions with ammonium ions in the NaY-type zeolite may be achieved by dispersing NaY-type zeolite in water to prepare a suspension and adding ammonium sulfate thereto. The mass ratio of zeolite to water may be in the range of 1:5 to 1:30, with a specific example of 1:10. Further, the solid matter may be washed with water, subsequently washed with an ammonium sulfate aqueous solution at a temperature of 40 to 80° C., followed by an additional wash with water at 40° C. to 95° C. The resulting zeolite may be dried at 100° C. to 180° C. for 30 minutes to obtain an ammonium-exchanged Y-type zeolite (NH₄⁵⁰⁻⁷⁰Y) in which 50 to 70% of Na contained in the Y-type zeolite is substituted with NH₄.

Subsequently, a hydrogen type Y-type zeolite (HY) is prepared by calcining the above ammonium-exchanged Y-type zeolite (NH₄⁵⁰⁻⁷⁰Y) at 500° C. to 800° C. for 10 minutes to 10 hours in a saturated steam atmosphere. An ammonium-exchanged Y-type zeolite (NH₄⁸⁰⁻⁹⁷Y) in which 80 to 97% of Na contained in the initial Y-type zeolite (NaY) is ion-exchanged with NH₄ may be obtained by dispersing the hydrogen type Y-type zeolite in water of 40° C. to 95° C. to prepare a suspension, further adding ammonium sulfate thereto, then stirring the suspension at 40° C. to 95° C. for 10 minutes to 3 hours. Further, the solid matter in the suspension may be washed with water at 40° C. to 95° C., subsequently washed with an ammonium sulfate aqueous solution at a temperature of 40° C. to 80° C., followed by an additional wash with water at 40° C. to 80° C. The resulting NH₄⁸⁰⁻⁹⁷Y zeolite may be dried at 100° C. to 180° C. for 30 minutes to 30 hours. In various embodiments, the final ammonium ion exchange rate is 90% or more, 92% or more, 94% or more, or approximately 95%. The ammonium-exchanged Y zeolite (NH₄⁸⁰⁻⁹⁷Y) thus obtained is calcined at 500° C. to 700° C. for 10 minutes to 10 hours in, for example, a saturated steam atmosphere, to generate an ultra-stable Y-type zeolite precursor (USY-a).

In one or more embodiments, extraskeletal aluminum may be removed from the USY-a to obtain the ultra-stable Y-type zeolite having a crystal lattice constant of 2.430 to 2.450 nm. It will be appreciated that extraskeletal aluminum represents aluminum atoms that do not form the zeolite framework. Extraskeletal aluminum can be removed by, for example, dispersing the USY-a in warm water of 40° C. to 95° C. to prepare a suspension, adding sulfuric acid to the suspension of the USY-a, and stirring for 10 minutes to 3 hours while maintaining the temperature at 40 to 95° C. to dissolve the extraskeletal aluminum. The amount of sulfuric acid shall not specifically be restricted as long as it is an amount by which extraskeletal aluminum can be dissolved to a desired level. After dissolving the extraskeletal aluminum, the suspension is filtered, and the residue retained on the filter is washed with purified water at 40° C. to 95° C. The washed filtrate may dried at 100° C. to 180° C. for 3 to 30 hours. Accordingly, the ultra-stable Y-type zeolite (USY) representing the USY-a from which the extraskeletal aluminum is removed may be obtained and may alternatively be referenced as USY-b for purposes of the present disclosure.

The resulting USY-b comprises a crystal lattice constant (UD) of 2.430 nm or more and 2.450 nm or less, a specific surface area of 600 to 900 m²/g and a molar ratio (silica-alumina ratio) of SiO₂ to Al₂O₃ of 20 to 100. It will be appreciated that it is important for obtaining the desired framework substituted Y-type zeolite to control the crystal lattice constant of the ultra-stable Y-type zeolite (USY-b) to 2.430 to 2.450 nm.

In accordance with one or more embodiments, the ultra-stable Y-type zeolite (USY-b) produced in accordance with the procedure disclosed supra, or in accordance with another technique known to those skilled in the art, is calcined at 500° C. to 700° C. In one or more further embodiments, the calcining is competed at 550° C. to 650° C. The calcining time shall not specifically be restricted as long as the targeted framework substituted Y-type zeolite is obtained, and it is calcined in a range of, for example, 30 minutes to 10 hours. If a calcining temperature of the ultra-stable Y-type zeolite is less than 500° C., a framework substitution amount of zirconium atoms, hafnium atoms and titanium atoms tends to be reduced when carrying out framework substitution treatment by zirconium atoms, hafnium atoms, or titanium atoms at a subsequent step as compared with a case in which calcining is carried out at 500° C. to 700° C. Conversely, if the calcining temperature exceeds 700° C., a specific surface area of the ultra-stable Y-type zeolite may be lowered, and a framework substitution amount of zirconium atoms, hafnium atoms, and titanium atoms may be reduced when carrying out framework substitution treatment by zirconium atoms, hafnium atoms, or titanium atoms at a subsequent step. In one or more embodiments, calcining ultra-stable Y-type zeolite (USY-b) is carried out in an atmosphere representative of air.

The calcined ultra-stable Y-type zeolite may be suspended in water having a temperature of about 20° C. to about 30° C. to form a suspension. In various embodiments, the suspension may have a liquid to solid mass ratio of 5 to 15, 6 to 14, or 8 to 12.

In one or more embodiments, an acid is added to the suspension of the calcined ultra-stable Y-type zeolite so that a pH of the suspension is controlled to less than 2.0. The acid may be an organic acid or an inorganic acid in the various embodiments of the present disclosure. Subsequently, a solution containing a adding and mixing one or more of a zirconium compound, a hafnium compound, or a titanium compound to the suspension is added and mixed into the suspension. The resulting mixed solution may be neutralized. In one or more embodiments, the mixed solution is neutralized to a pH of 7.0 to 7.5. The suspension is filtered, and the residue retained on the filter is washed with purified water. The washed filtrate may be dried at 80° C. to 180° C., whereby the framework substituted Y-type zeolite described supra may be obtained.

In one or more embodiments, the acid added to the suspension of the calcined ultra-stable Y-type zeolite may be an inorganic acid. In various embodiments, the inorganic acid may be sulfuric acid, nitric acid, hydrochloric acid, or another inorganic acid with similar chemical properties. It will be appreciated that sulfuric acid and hydrochloric acid have demonstrated desirable performance.

In one or more embodiments, the acid added to the suspension of the calcined ultra-stable Y-type zeolite may be an organic acid. In one or more embodiments, carboxylic acids may suitably be used to control the pH of the suspension to less than 2.0.

The amount of the inorganic acid or the organic acid shall not be restricted as long as a pH of the suspension can be controlled to less than 2.0. In various embodiments, the acid may be provided at a 0.5-fold to 4.0-fold molar amount or a 0.7-fold to 3.5-fold molar amount based on an amount of Al₂O₃ in the ultra-stable Y-type zeolite, but restriction to such ranges may not be necessary.

In various embodiments, the zirconium compound may comprise zirconium sulfate, zirconium nitrate, zirconium chloride, and other chemically similar species. It will be appreciated that zirconium sulfate and zirconium nitrate in particular have been demonstrated as having desirable performance. Generally, in accordance with the various embodiments, an aqueous solution of a zirconium compound prepared by dissolving the zirconium compound in water is suitably used as the zirconium compound.

In various embodiments, the hafnium compound may comprise hafnium chloride, hafnium nitrate, hafnium fluoride, hafnium bromide, hafnium oxalate, and other chemically similar species. It will be appreciated that hafnium chloride and hafnium nitrate in particular have been demonstrated as having desirable performance. Generally, in accordance with the various embodiments, an aqueous solution of a hafnium compound prepared by dissolving the hafnium compound in water is suitably used as the hafnium compound.

In various embodiments, the titanium compound may comprise titanium sulfate, titanium acetate, titanium chloride, titanium nitrate, or titanium lactate. It will be appreciated that titanium sulfate and titanium acetate in particular have been demonstrated as having desirable performance. Generally, in accordance with the various embodiments, an aqueous solution of a titanium compound prepared by dissolving the titanium compound in water is suitably used as the titanium compound.

In various embodiments, the total amount of the zirconium compound and the hafnium compound added to the pH adjusted suspension of the calcined Y-type zeolite is 0.1% to 5% by mass, 0.2% to 4%, or 0.3% to 3% by mass on a zirconium oxide and hafnium oxide basis with respect to the ultra-stable Y-type zeolite. Without wishing to be bound by theory, it is believed the addition of the zirconium compound and the hafnium compound at an amount of less than 0.1% by mass fails to improve the solid acid properties of the zeolite. Conversely, the addition of the zirconium compound and the hafnium compound in an amount exceeding 5% by mass may cause clogging of pores of the zeolite and unnecessary increase in cost of the resulting catalyst.

In various embodiments, the total amount of the titanium compound added to the pH adjusted suspension of the calcined Y-type zeolite is 0.1% to 5% by mass, 0.2% to 4%, 0.3% to 3%, or 0.6% to 3% by mass on a titanium oxide basis with respect to the ultra-stable Y-type zeolite. Without wishing to be bound by theory, it is believed the addition of the titanium compound at an amount of less than 0.1% by mass fails to generate an amount of a solid acid which effective for utilization in a hydrocracking reactor. Conversely, the addition of the titanium compound in an amount exceeding 5% by mass may cause clogging of pores of the zeolite with a commensurate reduction of activity in a hydrocracking reactor.

When the total presence of the zirconium compound and the hafnium compound on a mass percentage basis is provided within the bounds of the present disclosure, a mass ratio in terms of oxides of the zirconium atoms to the hafnium atoms need not be specifically restricted. Similarly, the mass ratio in terms of oxides of the zirconium/hafnium atoms to the titanium atoms need not be specifically restricted when their individual totals are within the disclosed ranges.

The zirconium atom content, the hafnium atom content, and the titanium atom content of the framework substituted Y-type zeolite may be measured with an X-ray fluorescence analyzer, a high frequency plasma emission spectrometer, or an atomic absorption spectrometer.

A pH of the suspension of the calcined Y-type zeolite should be controlled to less than 2.0 in advance of the addition of the zirconium compound, the hafnium compound, or the titanium compound to prevent or minimize precipitation during addition.

When adding an aqueous solution of the zirconium compound, the hafnium compound or the titanium compound to the suspension of the calcined Y-type zeolite, the aqueous solution may be gradually added to the suspension to allow for integration. Subsequently, the solution may be mixed by stirring for 3 to 5 hours at, for example, a temperature of about 25° C. to about 35° C. representative of room temperature.

In one or more embodiments, neutralization of the solution formed from the suspension of the calcined Y-type zeolite with one or more of the zirconium compound, the hafnium compound, or the titanium compound mixed in may comprise adding an alkali. An example of a suitable alkali is aqueous ammonia. The addition of the alkali may be completed in a quantity sufficient to adjust and control the pH of the mixture to 7.0 to 7.5. Adjustment of the pH to 7.0 to 7.5 results in generation of the framework substituted Y-type zeolite.

It will be appreciated that the addition of the zirconium compound, the hafnium compound, or the titanium compound in various combinations to the suspension of the calcined Y-type zeolite results in USY with varying aluminum atom substitutions and varying designations. For example, when only the zirconium compound is used as the compound added to the suspension of the calcined Y-type zeolite, the framework substituted Y-type zeolite is of type Zr-USY in which zirconium atoms are substituted for a part of the aluminum atoms forming the framework of the ultra-stable Y-type zeolite. Similarly, when only the hafnium compound is used as the compound added to the suspension of the calcined Y-type zeolite, the framework substituted Y-type zeolite is of type Hf-USY in which hafnium atoms are substituted for a part of the aluminum atoms forming the framework of the ultra-stable Y-type zeolite. When both the zirconium compound and the hafnium compound are used as the compound added to the suspension of the calcined Y-type zeolite, the framework substituted Y-type zeolite is of type Zr—Hf-USY in which zirconium atoms and hafnium atoms are substituted for a part of the aluminum atoms forming the framework of the ultra-stable Y-type zeolite. Finally, when the titanium compound is additionally used as the compound added to the suspension of the calcined Y-type zeolite, the framework substituted Y-type zeolite is of type Ti—Zr—USY, Ti—Hf—USY, or Ti—Zr—Hf-USY depending on if zirconium atoms, hafnium atoms, or both are substituted for a part of the aluminum atoms forming the framework of the ultra-stable Y-type zeolite.

The resulting framework substituted Y-type zeolite may be filtered, washed with water, and dried at about 80° C. to about 180° C.

The binder is also produced or provided for preparation of the hydrocracking catalyst. The binder supports, or acts as a carrier, for the framework substituted Y-type zeolite. In various embodiments, the binder comprises one or more inorganic oxides such as alumina, silica, titania, silica-alumina, alumina-titania, alumina-zirconia, alumina-boria, phosphorus-alumina, silica-alumina-boria, phosphorus-alumina-boria, phosphorus-alumina-silica, silica-alumina-titania, and silica-alumina-zirconia. It will be appreciated that an inorganic oxide mainly composed of alumina or silica-alumina has been demonstrated as providing the desired attributes.

To produce the catalyst precursor, the framework substituted Y-type zeolite, the binder, and one or more hydrogenative metal components are co-mulled. It will be appreciated that co-mulling the various components means that all the components are mixed together in a single operation without prior processing of a sub-set of the constituents to form an intermediary that is added to the remaining components. The generalized co-mulling procedure in accordance with one or more embodiments comprises mixing the framework substituted Y-type zeolite, the binder, and one or more hydrogenative metal components together in a single operation. The mixing may be achieved by concurrently providing each constituent component to a kneader. Continued kneading of the resulting mixture allows for control of the water content of the resulting mixed cake for further processing into the desired shape and size.

In one or more embodiments, the framework substituted Y-type zeolite and the binder are provided to the co-mulling process at a dry mass ratio of 2:98 to 80:20. In various further embodiments, the framework substituted Y-type zeolite and the binder are provided to the co-mulling process at a dry mass ratio of 0.1:99.9 to 90:10, 2:98 to 80:20, 10:90 to 80:20, 12:88 to 75:25, 20:80 to 70:30, 35:65 to 65:35, or approximately 1:1.

The hydrogenative metal component co-mulled with the framework substituted Y-type zeolite and the binder to form the catalyst precursor may comprise any known metal component for use in conventional hydrocracking catalysts. In various embodiments, the hydrogenative metal component may comprise one or more IUPAC group 6, one or more IUPAC group 8 metals, or combinations thereof. For example, the hydrogenative metal component may comprise one or more IUPAC group 8 metals selected from iron, cobalt, nickel, rhodium, palladium, silver, iridium, platinum or gold, one or more IUPAC group 6 metals selected from chromium, molybdenum or tungsten, as well as combinations thereof. In one or more specific embodiments, the hydrogenative metal component comprises combinations of molybdenum or tungsten in group 6 and cobalt or nickel in group 8. In one or more further embodiments, the hydrogenative metal component comprises one or more of platinum, rhodium, and palladium.

The hydrogenative metal component may be contained in the hydrocracking catalyst in an amount generally accepted as efficacious for use in a hydrocracking catalyst to those skilled in the art. In one or more embodiments, the hydrogenative metal component may be co-mulled with the framework substituted Y-type zeolite and the binder at 0.5 to 40% by mass, 1 to 36% by mass, 2 to 33% by mass, or 3 to 30% by mass in terms of the metal oxide form of the hydrogenative metal. For example, with molybdenum, tungsten, cobalt or nickel where the metal component forms and may be provided as an oxide, the mass percentage is based on the oxide form. In one or more embodiments, the hydrogenative metal component may be co-mulled with the framework substituted Y-type zeolite and the binder at 0.01 to 5% by mass, 0.01 to 4% by mass, 0.01 to 3% by mass, or 0.01 to 2% by mass in terms of the elemental metal. For example, with platinum, rhodium, or palladium where the metal component does not form an oxide, the mass percentage is based on the elemental metal.

The catalyst precursor formed by co-mulling the framework substituted Y-type zeolite, the binder, and one or more hydrogenative metal components is calcined to generate the hydrocracking catalyst. In one or more embodiments, the catalyst precursor is calcined in air at 400° C. to 650° C. for a period of 10 minutes to 3 hours.

Having described embodiments of methods for producing a hydrocracking catalyst, further detail regarding the properties of the various materials and components utilized in the disclosed methods shall be provided.

The framework substituted Y-type zeolite comprises a crystal lattice constant, a specific surface area, a molar ratio of SiO₂ to Al₂O₃, (silica-alumina ratio), and a crystallinity which are within predetermined desirable ranges.

In various embodiments, the framework substituted Y-type zeolite comprises a crystal lattice constant of 2.430 to 2.450 nm, 2.432 to 2.448 nm, or 2.435 to 2.445 nm. A crystal lattice constant for the framework substituted Y-type zeolite of less than 2.430 nm may result in a reduction in the activity of the ultimately formed hydrocracking catalyst. Such reduction is believed to be the result of a high SiO₂/Al₂O₃ molar ratio in the framework structure of the zeolite and a small number of solid acid sites serving as active sites for the decomposition of hydrocarbons. Conversely, a crystal lattice constant for the framework substituted Y-type zeolite exceeding 2.450 nm may result in breakage of the crystal structure of the framework substituted Y-type zeolite during a hydrocracking reaction because of a low heat resistance of the framework substituted Y-type zeolite. The breakage of the crystal structure of the framework substituted Y-type zeolite may result in a reduction in the activity of the ultimately formed hydrocracking catalyst.

The crystal lattice constant can be determined by ASTM D3942-03, entitled “Standard Test Method for Determination of the Unit Cell Dimension of a Faujasite-Type Zeolite,” the entire content of which is incorporated herein by reference.

In various embodiments, the framework substituted Y-type zeolite comprises a specific surface area of 600 to 900 m²/g, 625 to 850 m²/g, or 650 to 800 m²/g. The specific surface area may be determined in accordance with the Brunauer-Emmett-Teller (BET) method using nitrogen adsorption. Such method is known to those having skill in the art. A specific surface area of the framework substituted Y-type zeolite of less than 600 m²/g may result in a reduction in the number of solid acid sites effective for a hydrocracking reactor, thereby reducing the catalyst activity of the resulting hydrocracking catalyst to an unsatisfactory level.

In various embodiments, the framework substituted Y-type zeolite comprises a molar ratio of SiO₂ to Al₂O₃ (silica-alumina ratio) of 20 to 100, 22 to 95, 24 to 85, or 25 to 80. A silica-alumina ratio of the framework substituted Y-type zeolite of less than 20 may not result in an effective pore volume for a hydrocracking reactor and is thus liable to cause a reduction in activity in hydrogenation and hydrocracking of the ultimately formed hydrocracking catalyst. Conversely, a silica-alumina ratio of the framework substituted Y-type zeolite exceeding 100 may result in a reduction in activity in a decomposition reactor of the ultimately prepared hydrocracking catalyst because of a small number of solid acid sites effective for hydrocracking.

In various embodiments, the framework substituted Y-type zeolite comprises a crystallinity of at least 80%, at least 90%, at least 100%, or 100% to 130%. Crystallinity may be determined in accordance with methods known to those skilled in the art. One such method includes determining the total height (H) of peaks measured by X-ray diffraction of the framework substituted Y-type zeolite from the (331), (511), (440), (533), (642), and (555) planes. The total height (H₀) of peaks from the same planes of a commercially available Y zeolite, for example, SK-40 (manufactured by Union Carbide Corporation), are determined as a reference. The crystallinity is ultimately determined in accordance with Formula (1) presented infra.

Crystallinity (%)=H/H₀×100 Formula (1)

It will be appreciated that the disclosed ranges for the lattice constant, specific surface area, crystallinity, and molar ratio of SiO₂ to Al₂O₃ provided for the framework substituted Y-type zeolite may also be applied to the ultra-stable Y-type zeolite (USY-b) and calcined Y-type zeolite (USY-c).

### EXAMPLES

The described embodiments will be further clarified by the following example.

The various analytical methods used in the characterization of the Examples are provided infra.

Composition Analysis—An X-ray fluorescence analyzer (“RIX3000” manufactured by Rigaku Corporation) was used to carry out composition analysis (Zr, Hf, Ti, Mo or Ni) of each sample. Each sample for measurement was prepared in accordance with a glass bead method. Specifically, 5 g. of the sample was placed in a vinyl chloride-made ring having an inner diameter of 35 mm and molded by applying a pressure of 20 t for 20 seconds by means of a pressure molding machine to prepare the sample for measurement. X-ray fluorescence analysis was completed with the following parameters: target: Rh, analyzing crystal: LiF, detector: scintillation counter, excitation: Rh vessel of 4 kW, measuring voltage: 55 kV, and current: 70 mA.

Measurement of Sodium in Zeolite—An atomic absorption spectrometer (“Z5300” manufactured by HORIBA Ltd.) was used to measure a sodium content in each sample. The measuring wavelength range was controlled to 190 to 900 nm.

Crystal Lattice Constant—An X-ray diffractometer (“RINT2100” manufactured by Rigaku Corporation) was used to measure an X-ray diffraction peak of each sample, and the crystal lattice constant was calculated from the result thereof. X-ray diffraction was completed with the following parameters: vessel: Cu-K (α ray), 20 scanning range: 20 to 50°, scanning speed: 0.01°/minute, and scanning step: 0.01°.

Crystallinity—The crystallinity of each sample was calculated in accordance with Formula (1) presented supra. Accordingly, the total height (H) of peaks measured by X-ray diffraction of the sample zeolite from the (331), (511), (440), (533), (642), and (555) planes and the total height (H₀) of peaks from the same planes of a reference commercially available Y zeolite (SK-40, manufactured by Union Carbide Corporation), were determined and applied to Formula (1).

SiO₂/Al₂O₃ Molar Ratio—A peak intensity ratio of Si and Al was determined from an X-ray diffraction peak of each sample, and it was reduced to a molar ratio of SiO₂ to Al₂O₃.

Specific Surface Area and Pore Volume—Adsorption measuring equipment (fully automatic gas adsorption equipment “AUTOSORB-1” manufactured by Quantachrome Instruments Corporate) was used to subject 0.02 to 0.05 g. of a sample to deaeration treatment at room temperature for 5 hours, and then an adsorption desorption isothermal curve was measured under liquid nitrogen temperature to calculate a specific surface area per mass using a BET equation of a multipoint method. Further, a pore distribution and a pore volume (pore diameter: 600 Λ or less) were calculated from a nitrogen adsorption isothermal curve by a BJH (Barrett, Joyner, and Halenda) method.

### Inventive Example 1

Preparation of Ultra-Stable Y-type Zeolite

First, 50.0 kg of a NaY zeolite (hereinafter, also referred to as “NaY”) having a SiO₂/Al₂O₃ molar ratio of 5.2, a crystal lattice contant of 2.466 nm, a specific surface area (SA) of 720 m²/g, and a Na₂O content of 13.0% by mass was suspended in 500 liter of water having a temperature of 60° C. Furthermore, 14.0 kg of ammonium sulfate was added thereto. The resulting suspension was stirred at 70° C. for 1 hour and filtered. The resulting solid was washed with water. Then the solid was washed with an ammonium sulfate solution of 14.0 kg of ammonium sulfate dissolved in 500 L of water having a temperature of 60° C., washed with 500 L of water having a temperature of 60° C., dried at 130° C. for 20 hours, thereby affording about 45 kg of a Y-type zeolite (NH₄⁶⁵Y) in which 65% of sodium (Na) contained in NaY was ion-exchanged with ammonium ion (NH₄⁺). A content of Na₂O in NH₄⁶⁵Y was 4.5% by mass.

NH₄⁶⁵Y 40 kg was fired in a saturated water vapor atmosphere at 670° C. for 1 hour to form a hydrogen-Y zeolite (HY). HY was suspended in 400 L of water having a temperature of 60° C. Then 49.0 kg of ammonium sulfate was added thereto. The resulting mixture was stirred at 90° C. for 1 hour and washed with 200 L of water having a temperature of 60° C. The mixture was then dried at 130° C. for 20 hours, thereby affording about 37 kg of a Y zeolite (NH₄⁹⁵Y) in which 95% of Na contained in the initial NaY was ion-exchanged with NH₄. 33.0 kg of NH₄⁹⁵Y was fired in a saturated water vapor atmosphere at 650° C. for 1 hour, thereby affording about 15 kg of a ultra-stable Y zeolite (USY-a) having a SiO₂/Al₂O₃ molar ratio of 5.2 and a Na₂O content of 0.60% by mass. The properties of USY-a are provided in Table 1.

Next, 26.0 kg of this USY-a was suspended in 260 L of water having a temperature of 60° C. After 61.0 kg of 25% sulfuric acid by mass was gradually added to the suspension, the suspension was stirred at 70° C. for 1 hour. The suspension was filtered. The resulting solid was washed with 260 liter of deionized water having a temperature of 60° C. and dried at 130° C. for 20 hours, thereby affording an ultra-stable Y-type zeolite (USY-b). The properties of USY-b are provided in Table 1.

USY-b was fired at 600° C. for 1 hour, thereby affording about 17 kg of calcined ultra-stable Y-type zeolite (USY-c). The properties of USY-c are provided in Table 1.

Preparation of Framework Substituted Y-type Zeolite, namely Ti—Zr-USY

First, 1 kg of USY-c was suspended in 10 L of water having a temperature of 25° C. The pH of the suspension was adjusted to 1.6 with 25% sulfuric acid by mass. Then 86 g of a solution containing 18% zirconium sulfate by mass and 45 g of a solution containing 33% titanium sulfate by mass was added thereto. The resulting mixture was stirred for 3 hours at room temperature. Then the pH was adjusted to 7.2 with 15% aqueous ammonia by mass. After the mixture was stirred for 1 hour at room temperature, the mixture was filtered. The resulting solid was washed with 10 L of water and dried at 130° C. for 20 hours, thereby affording about 1 kg of a titanium-zirconium-substituted zeolite (Ti—Zr-USY).

Preparation of Hydrocracking Catalyst A

First, 40 kg of an aqueous solution of 6.8% sodium aluminate by mass on an Al₂O₃ basis was mixed with 40 kg of an aqueous solution of 2.4% aluminum sulfate by mass on an Al₂O₃ basis. Further, the mixture was stirred at 60° C. for 1 hour, and then the product was washed with 150 L of a 0.3 mass % ammonia aqueous solution to remove Na₂SO₄. Next, water was added to the product from which Na₂SO₄ was removed to adjust an Al₂O₃ concentration to 10% by mass. The pH was adjusted to 10.5 with 15% aqueous ammonia by mass. The mixture was stirred at 95° C. for 10 hours, dehydrated, washed, and kneaded with a kneader, thereby providing an alumina mixture.

The resulting alumina mixture was co-mulled with Ti—Zr-USY in a dry mass ratio of 1:1 along with an aqueous solution containing hydrogenation-active metal components. The aqueous solution containing hydrogenation-active metal components was prepared by adding 700 mL of water to 201.3 g of molybdenum trioxide (an example of the hydrogenation-active metal component) and 90.4 g of nickel carbonate (an example of the hydrogenation-active metal component) and stirring the resulting mixture at 95° C. for 5 hours. The mixture of Ti—Zr-USY, the alumina mixture (binder), and hydrogenation-active metal components was formed into a columnar shape having a diameter of 1.8 mm, and fired at 550° C. for 3 hours, thereby preparing Hydrocracking Catalyst A. The properties of Hydrocracking Catalyst A are provided in Table 2.

### Comparative Example 2

Preparation of Hydrocracking Catalyst B

Ti—Zr-USY and the alumina mixture obtained in Inventive Example 1 were similarly prepared. The resulting alumina mixture was mixed with Ti—Zr-USY in a dry mass ratio of 1:1. The mixture was kneaded with a kneader, formed into a columnar shape having a diameter of 1.8 mm, and fired at 550° C. for 3 hours, thereby affording support B. The support B was immersed in an aqueous solution containing hydrogenation-active metal components and fired in the air at 550° C. for 1 hour, thereby affording hydrocracking catalyst B. Here, the aqueous solution containing hydrogenation-active metal components was prepared in the same manner as that of Inventive Example 1. The properties of Hydrocracking Catalyst B are provided in Table 2.

TABLE 1

| | Silica- | Crystal Lattice | Specific | |
|---|---|---|---|---|
| | Alumina | Constant | Surface Area | Crystallinity |
| | Ratio | (nm) | (m²/g) | (%) |
| USY-a | 5.2 | 2.438 | 635 | 98 |
| USY-b | 30.2 | 2.436 | 710 | 105 |
| USY-c | 30.1 | 2.436 | 712 | 105 |

TABLE 2

| | | Hydrocracking | Hydrocracking |
|---|---|---|---|
| | | Catalyst A | Catalyst B |
| | | (Inventive | (Comparative |
| Property | Unit | Example 1) | Example 2) |
| Surface Area | m²/g | 408 | 330 |
| (SA) | | | |
| Pore Volume | ml/g | 0.60 | 0.65 |
| (PV) | | | |
| Compact Bulk | g/ml | 0.66 | 0.65 |
| Density (CBD) | | | |

As shown in Table 2, the method of Inventive Example 1 produces a hydrocracking catalyst with more surface area, but less pore volume than that of Comparative Example 2. The indication of more surface area in Inventive Example 1 than the Comparative Example 2 indicates that Inventive Example 1 may serve as good candidate catalyst for the second stage reactor in a hydrocracking system.

It should now be understood the various aspects of the method for producing a hydrocracking catalyst are described and such aspects may be utilized in conjunction with various other aspects.

In a first aspect, the disclosure provides a method for producing a hydrocracking catalyst. The method comprises preparing a framework substituted Y-type zeolite, preparing a binder, co-mulling the framework substituted Y-type zeolite, the binder, and one or more hydrogenative metal components to form a catalyst precursor, and calcining the catalyst precursor to generate the hydrocracking catalyst. The framework substituted Y-type zeolite is prepared by: calcining a Y-type zeolite at 500° C. to 700° C. to form a calcined Y-type zeolite, the Y-type zeolite having a crystal lattice constant falling in an inclusive range of 2.430 to 2.450 nm, a specific surface area of 600 to 900 m²/g, and a molar ratio of SiO₂ to Al₂O₃ of 20 to 100. Further, the preparing the framework substituted Y-type zeolite comprises forming a suspension containing the calcined Y-type zeolite, the suspension having a liquid to solid mass ratio of 5 to 15, adding acid to adjust the pH of the suspension to less than 2.0, adding and mixing one or more of a zirconium compound, a hafnium compound, or a titanium compound to the suspension to the suspension, and neutralizing the pH of the suspension to obtain the framework substituted Y-type zeolite.

In a second aspect, the disclosure provides the method of the first aspect in which the titanium compound is added to the suspension.

In a third aspect, the disclosure provides the method of the second aspect in which the zirconium compound is added and mixed in addition to the titanium compound to the suspension, the resulting framework substituted Y-type zeolite being a titanium-zirconium substituted Y-type zeolite.

In a fourth aspect, the disclosure provides the method of any of the first through third aspects in which the framework substituted Y-type zeolite and the binder are co-mulled at a dry mass ratio of 0.1:99.9 to 90:10 or 2:98 to 80:20.

In a fifth aspect, the disclosure provides the method of any of the first through third aspects in which the framework substituted Y-type zeolite and the binder are co-mulled at a dry mass ratio of 10:90 to 80:20 or 35:65 to 65:35.

In a sixth aspect, the disclosure provides the method of any of the first through fifth aspects in which the one or more hydrogenative metal components comprise one or more IUPAC group 6 and IUPAC group 8 metals.

In a seventh aspect, the disclosure provides the method of any of the first through sixth aspects in which the hydrogenative metal components comprise molybdenum and nickel.

In an eighth aspect, the disclosure provides the method of any of the first through seventh aspects in which the hydrogenative metal components comprise molybdenum trioxide and nickel oxide.

In a ninth aspect, the disclosure provides the method of any of the first through eighth aspects in which the hydrocracking catalyst comprises 0.01 to 40% by mass of the hydrogenative metal component.

In a tenth aspect, the disclosure provides the method of any of the first through ninth aspects in which the binder comprises alumina or silica-alumina.

In an eleventh aspect, the disclosure provides the method of any of the first through tenth aspects in which the catalyst precursor is calcined in air at 400° C. to 650° C. for a period of 10 minutes to 3 hours.

In a twelfth aspect, the disclosure provides the method of any of the first through eleventh aspects in which the Y-type zeolite is an ultra-stable Y-type zeolite (USY).

In a thirteenth aspect, the disclosure provides the method of the twelfth aspect in which the USY is formed by: (i) suspending a NaY-type zeolite in water at a mass ratio of zeolite to water of 1:20 to 1:5 to prepare a first solution; (ii) adding ammonium sulfate to the first solution to generate a Y-type zeolite in which 50 to 70% of sodium in the NaY-type zeolite is ion-exchanged with ammonium ions (NH₄⁵⁰⁻⁷⁰Y); (iii) calcining the NH₄⁵⁰⁻⁷⁰Y in a saturated steam atmosphere at 500° C. to 800° C. for 10 minutes to 10 hours generate a hydrogen type Y-type zeolite; iv) suspending the hydrogen type Y-type zeolite in water and adding ammonium sulfate to generate a Y-type zeolite in which 80 to 97% of sodium originally in the NaY-type zeolite is ion-exchanged with ammonium ions (NH₄⁸⁰⁻⁹⁷Y); (v) calcining the NH₄⁸⁰⁻⁹⁷Y in a saturated steam atmosphere at 500° C. to 700° C. for 10 minutes to 10 hours generate a USY precursor (USY-a); and (vi) suspending the USY-a in water and adding sulfuric acid thereto to generate the USY.

In a fourteenth aspect, the disclosure provides the method of the thirteenth aspect in which the water in steps (i), (iv), and (vi) is maintained at 40° C. to 95° C.

In a fifteenth aspect, the disclosure provides the method of the thirteenth or fourteenth aspect in which the NaY-type zeolite is suspended in water at a mass ratio of zeolite to water of 1:10 to prepare the first solution.

In a sixteenth aspect, the disclosure provides the method of any of the thirteenth through fifteenth aspects in which approximately 65% of sodium in the NaY-type zeolite is ion-exchanged with ammonium ions in step (ii).

In a seventeenth aspect, the disclosure provides the method of any of the thirteenth through sixteenth aspects in which approximately 95% of sodium originally in the NaY-type zeolite is ion-exchanged with ammonium ions in step (iv).

In an eighteenth aspect, the disclosure provides the method of any of the thirteenth through seventeenth aspects in which the catalyst precursor is formed into a columnar shape having a diameter less than 4 mm prior to calcining or in the range of ⅛ to 1/32 inch.

It should be apparent to those skilled in the art that various modifications and variations can be made to the described embodiments without departing from the spirit and scope of the claimed subject matter. Thus, it is intended that the specification cover the modifications and variations of the various described embodiments provided such modifications and variations come within the scope of the appended claims and their equivalents.

The singular forms “a”, “an” and “the” include plural referents, unless the context clearly dictates otherwise.

Throughout this disclosure ranges are provided. It is envisioned that each discrete value encompassed by the ranges are also included. Additionally, the ranges which may be formed by each discrete value encompassed by the explicitly disclosed ranges are equally envisioned. For brevity, the same is not explicitly indicated subsequent to each disclosed range and the present general indication is provided.

As used in this disclosure and in the appended claims, the words “comprise,” “has,” and “include” and all grammatical variations thereof are each intended to have an open, non-limiting meaning that does not exclude additional elements or steps.

What is claimed is:

1. A method for producing a hydrocracking catalyst, the method comprising:
preparing a framework substituted Y-type zeolite, wherein the framework substituted Y-type zeolite is prepared by:
calcining a Y-type zeolite at 500° C. to 700° C. to form a calcined Y-type zeolite, the Y-type zeolite having a crystal lattice constant failing in an inclusive range of 2.430 to 2.450 nm, a specific surface area of 600 to 900 m²/g, and a molar ratio of SiO₂ to Al₂O₃ of 20 to 100;
forming a suspension containing the calcined Y-type zeolite, the suspension having a liquid to solid mass ratio of 5 to 15;
adding acid to adjust the pH of the suspension to less than 2.0;
adding and mixing one or more of a zirconium compound, a hafnium compound, or a titanium compound to the suspension; and
neutralizing the pH of the suspension to obtain the framework substituted Y-type zeolite;
preparing a binder;
co-mulling the framework substituted Y-type zeolite, the binder, and one or more hydrogenative metal components to form a catalyst precursor; and
calcining the catalyst precursor to generate the hydrocracking catalyst.

2. The method of claim 1, where the titanium compound is added to the suspension.

3. The method of claim 2, where the zirconium compound is added and mixed in addition to the titanium compound to the suspension, the resulting framework substituted Y-type zeolite being a titanium-zirconium substituted Y-type zeolite.

4. The method of claim 1, where the framework substituted Y-type zeolite and the binder are co-mulled at a dry mass ratio of 0.1:99.9 to 90:10.

5. The method of claim 1, where the framework substituted Y-type zeolite and the binder are co-mulled at a dry mass ratio of 10:90 to 80:20.

6. The method of claim 1, where the one or more hydrogenative metal components comprise one or more IUPAC group 6 and IUPAC group 8 metals.

7. The method of claim 6, where the hydrogenative metal components comprise molybdenum and nickel.

8. The method of claim 7, where the hydrogenative metal components comprise molybdenum trioxide and nickel oxide.

9. The method of claim 1, where the hydrocracking catalyst comprises 0.01 to 40% by mass of the hydrogenative metal component.

10. The method of claim 1, where the binder comprises alumina.

11. The method of claim 1, where the binder comprises silica-alumina.

12. The method of claim 1, where the catalyst precursor is calcined in air at 400° C. to 650° C. for a period of 10 minutes to 3 hours.

13. The method of claim 1, where the Y-type zeolite is an ultra-stable Y-type zeolite (USY).

14. The method of claim 13, where the USY is formed by:
(i) suspending a NaY-type zeolite in water at a mass ratio of zeolite to water of 1:5 to 1:30 to prepare a first solution;
(ii) adding ammonium sulfate to the first solution to generate a Y-type zeolite in which 50 to 70% of sodium in the NaY-type zeolite is ion-exchanged with ammonium ions (NH₄⁵⁰⁻⁷⁰Y);
(iii) calcining the NH₄⁵⁰⁻⁷⁰Y in a saturated steam atmosphere at 500° C. to 800° C. for 10 minutes to 10 hours generate a hydrogen type Y-type zeolite;
iv) suspending the hydrogen type Y-type zeolite in water and adding ammonium sulfate to generate a Y-type zeolite in which 80 to 97% of sodium originally in the NaY-type zeolite is ion-exchanged with ammonium ions (NH₄⁸⁰⁻⁹⁷Y);
(v) calcining the NH₄⁸⁰⁻⁹⁷Y in a saturated steam atmosphere at 500° C. to 700° C. for 10 minutes to 10 hours generate a USY precursor (USY-a); and
(vi) suspending the USY-a in water and adding sulfuric acid thereto to generate the USY.

15. The method of claim 14, where the water in steps (i), (iv), and (vi) is maintained at 40° C. to 95° C.

16. The method of claim 14, where the NaY-type zeolite is suspended in water at a mass ratio of zeolite to water of 1:10 to prepare the first solution.

17. The method of claim 14, where approximately 65% of sodium in the NaY-type zeolite is ion-exchanged with ammonium ions in step (ii).

18. The method of claim 14, where approximately 95% of sodium originally in the NaY-type zeolite is ion-exchanged with ammonium ions in step (iv).

19. The method of claim 1, where the catalyst precursor is formed into a columnar shape having a diameter less than 4 mm prior to calcining.
